(19) United States
(12) Patent Application Publication
(10) Pub. No.: US 2012/0038565 A1
(43) Pub. Date: Feb. 16, 2012

(54) TOUCH DISPLAY DEVICE

(75) Inventor: MENGYING LIN, Dali City (TW)

(73) Assignee: CHIMEI INNOLUX CORPORATION, Miaoli County (TW)

(21) Appl. No.: 13/162,004

(22) Filed: Jun. 16, 2011

(30) Foreign Application Priority Data
Aug. 11, 2010 (TW) 99126735

(51) Int. Cl. G06F 3/041

(52) U.S. Cl. 345/173

(57) ABSTRACT

A touch display device is provided. The touch display device includes a display panel, a plurality of horizontal sensing lines, a plurality of vertical sensing lines, a horizontal voltage selector, a vertical voltage selector, and a control chip. The display panel includes a plurality of sensing elements arranged in matrix form, and the plurality of the horizontal sensing lines and the plurality of vertical sensing lines are connected with the plurality of the sensing elements, respectively. The horizontal voltage selector is configured to receive a plurality of horizontal sensing signals from the plurality of horizontal sensing lines, and the vertical voltage selector is configured to receive a plurality of vertical sensing signals from the plurality of vertical sensing lines. The control chip is configured to output a plurality of horizontal control signals to the horizontal voltage selector and output a plurality of vertical control signals to the vertical voltage selector, whereby the horizontal voltage selector outputs one of the plurality of horizontal sensing signals to the control chip based on the plurality of horizontal control signals, and the vertical voltage selector outputs one of the plurality of vertical sensing signals to the control chip based on the plurality of vertical control signals.

### FIELD OF THE INVENTION

The present invention relates to a touch display device, and more particularly to a touch display panel with reduced frame width.

### BACKGROUND OF THE INVENTION

The use of touch display devices can not only conserve the space for deploying conventional mouse and keyboard, but also provide more user-friendly operations, therefore becoming one of the major interfaces of the electronic devices or machines. Currently, the in-cell touch technology integrating the touch sensing element into the pixel structure can provide better contrast and brightness than the conventional touch display device and thus receives more and more attentions.

FIG. 1 illustrates the pixel structure 100 of a conventional touch display device, wherein the pixel structure 100 includes three sub-pixels: red (R), green (G), and blue (B). In general, each sub-pixel 110, 120, 130 includes a transistor and a pixel electrode and is driven by a gate line 140 and one of the three data lines 150, 152, and 154. For touch sensing function, each pixel structure is disposed with two sensing elements 160 and 162, which sense x coordinate and y coordinate of the touch point, respectively. The structure of sensing elements 160 and 162 is typically a protrusion between the upper color filter substrate and the lower TFT array substrate of the display panel. When under pressing, the protrusion electrically conducts the upper substrate with the lower substrate. Thus, when an object touches the display panel, the sensing elements 160 and 162 of the pixel structure 100 corresponding to the touch position will generate a corresponding signal, wherein the signal can be transmitted to other circuitry of the display panel through the sensing lines 170 and 172 for further processing.

FIG. 2 illustrates a block diagram of the conventional touch display device 200. The display device 200 includes a display panel 210, Y-direction sensing circuits 220 and 222, an X-direction sensing circuit 230, gate-line driving circuits 240 and 242, a data line driving circuit 250, and a control chip 260. The display panel 210 includes a plurality of pixel structures of FIG. 1 arranged in matrix form, wherein the gate-line driving circuits 240, 242 and the data line driving circuit 250 update the display data in each pixel structure of the display panel 210. The horizontal sensing element in each pixel structure (e.g. the sensing element 160 of FIG. 1) is connected to the X-direction sensing circuit 230 through 2ⁿ sensing lines X(1), X(2), . . . , X(2ⁿ). The vertical sensing element in each pixel structure (e.g. the sensing element 162 of FIG. 1) is respectively connected to the 2^{m} sensing lines Y(1), Y(2), . . . , Y(2^{m}), wherein the odd number sensing lines Y(1), Y(3), . . . , Y(2^{m}−1), total 2^{m-1} sensing lines, are connected to the Y-direction sensing circuit 220, while the even number sensing lines Y(2), Y(4), . . . , Y(2^{m}), total 2^{m-1} sensing lines, are connected to the Y-direction sensing circuit 222. The control chip 260 receives and processes signals from the 2ⁿ sensing lines of the X-direction sensing circuit 230, signals from the 2^{m-1} sensing lines of the Y-direction sensing circuit 220, and signals from the 2^{m-1} sensing lines of the Y-direction sensing circuit 222 to obtain data associated with the touch position on the display panel 210.

Referring to FIG. 2, in order to prevent one side frame width of the touch display device 200 from widening, the sensing lines Y(1), Y(2), . . . , Y(2^{m}) are connected to two sides (e.g. left and right sides) of the display panel 210, respectively. However, the Y-direction sensing circuit 220 or 222 still needs to output 2^{m-1} sensing lines to the control chip 260. Such huge amount of sensing lines will result in overlarge frame width (D). Moreover, the control chip 260 also requires a large amount of pins for receiving sensing signals. As the resolution of display panel 210 is promoted, the above problems become more serious.

Therefore, there is a need to provide a sensing circuit structure capable of effectively reducing the frame width of the touch display device and decreasing the amount of the pins required in the control chip.

### SUMMARY OF THE INVENTION

Accordingly, the present invention has been made keeping in mind the above problems occurring in the prior art, and one aspect of the present invention is to provide a touch display device, which includes a voltage selector to substitute the routing of large amount of signal lines.

In one aspect of the present invention, by means of a relatively smaller amount of sensing lines, the X-direction sensing lines and the Y-direction sensing lines in the touch display device are outputted to the control chip through a single output end of the voltage selector, thereby significantly reducing the frame width and simultaneously decreasing the number of pins required in the control chip.

In one embodiment, the present invention provides a touch display device including a display panel, a plurality of horizontal sensing lines, a horizontal voltage selector, and a control chip. The display panel includes a plurality of sensing elements arranged in matrix form, wherein the plurality of horizontal sensing lines are connected to the plurality of sensing elements, respectively. The horizontal voltage selector is configured to receive a plurality of horizontal sensing signals from the plurality of the horizontal sensing lines, and the control chip is configured to output a plurality of horizontal control signals to the horizontal voltage selector. The horizontal voltage selector outputs one of the plurality of horizontal sensing signals to the control chip based on the plurality of horizontal control signals.

Other aspects of the present invention solve other problems and are disclosed and illustrated in detail with the embodiments below together with the aforesaid aspects. Various aspects of the present invention can be understood and implemented with the elements and combinations specified in the accompanied claims. However, it should be understood the foregoing contents and the following detailed description are only illustrative and not in a limited sense.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. While the invention is illustrated with preferred embodiments, those skilled in the art will understand the present invention is not limited to arrangements and elements described therein. In the drawings:

FIG. 1 illustrates a pixel structure of a conventional touch display device;

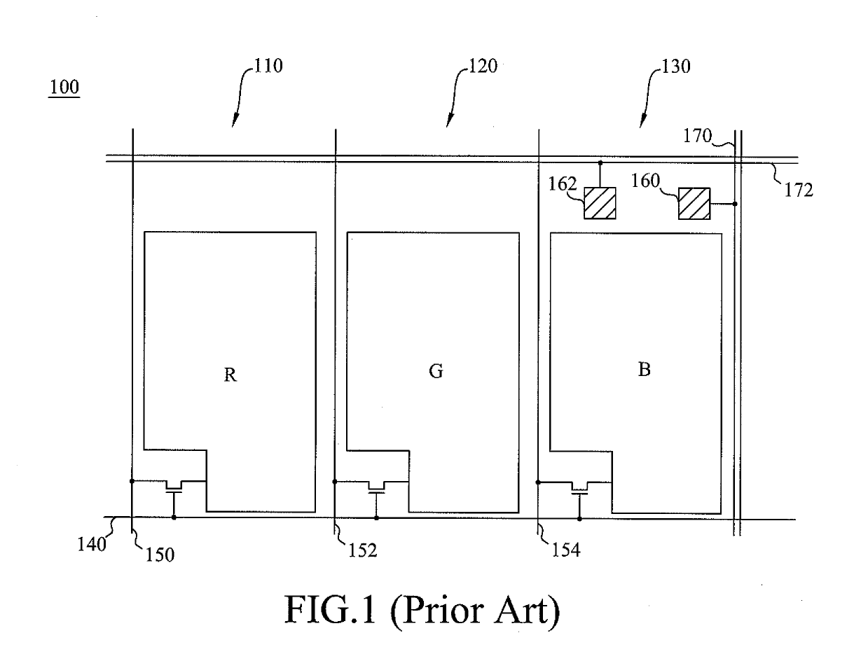

FIG. 2 illustrates a block diagram of a conventional touch display device;

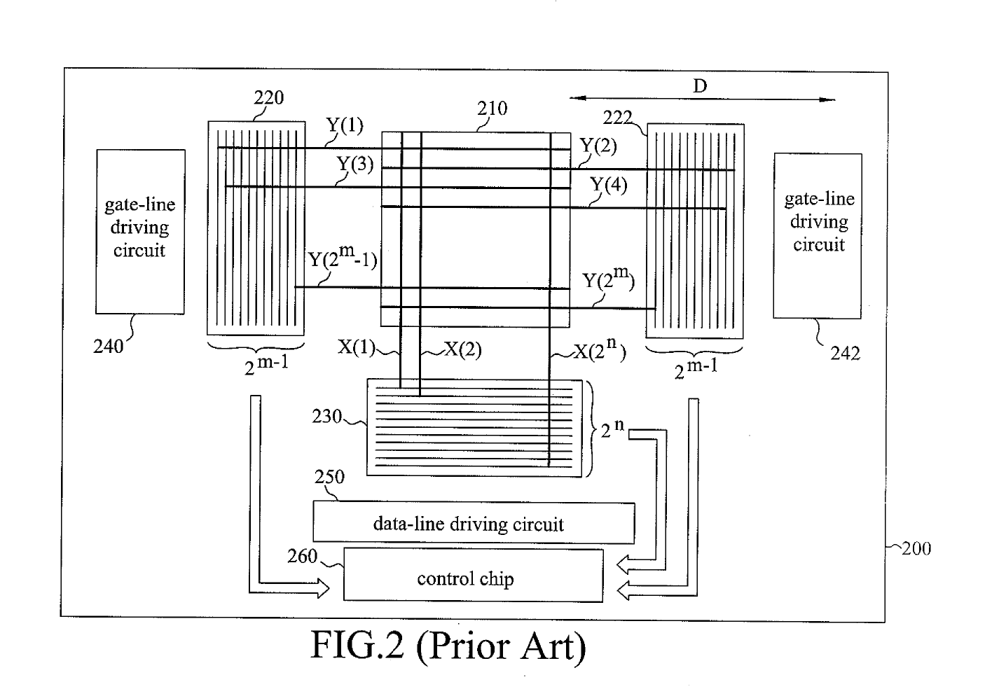

FIG. 3 is a block diagram of a touch display device in accordance with one embodiment of the present invention;

FIG. 4 illustrates a logic circuit diagram of the voltage selector in accordance with one embodiment of the present invention; and

FIG. 5 illustrates a logic circuit diagram of the voltage selector in accordance with another embodiment of the present invention.

### DETAILED DESCRIPTION OF THE INVENTION

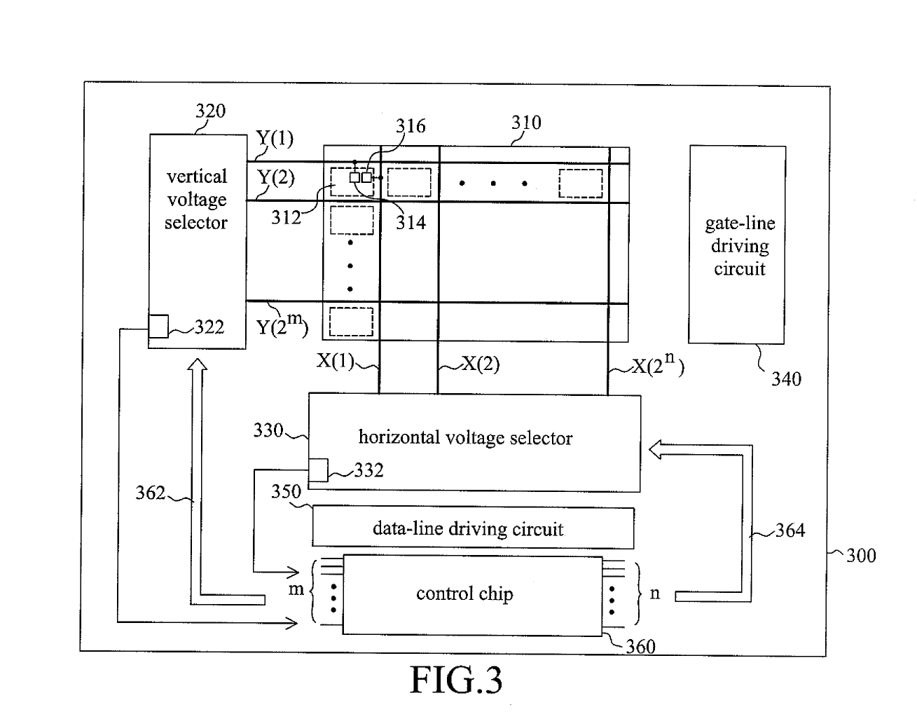

The present invention discloses a touch display device including at least one voltage selector circuit for reducing the number of signal lines connected to the control chip to further reduce the frame width of the display device. The preferred embodiments of the present invention will now be described in greater details by referring to the following descriptions in reference with FIG. 3 through FIG. 5. The devices, elements, and processing steps described in the following embodiments are provided to illustrate the present invention and are not intended to be restrictive of the scope of the present invention.

FIG. 3 is a block diagram of a touch display device 300 in accordance with one embodiment of the present invention. The touch display device 300 includes a display panel 310, a vertical voltage selector 320, a horizontal voltage selector 330, a gate-line driving circuit 340, a data-line driving circuit 350, and a control chip 360.

The display panel 310 includes a plurality of pixel structures 312 consisting of a TFT array substrate, a color filter substrate, and a liquid crystal layer sandwiched between the two substrates. In general, each pixel structure 312 can include three sub-pixels: red (R), green (G), blue (B), and each sub-pixel includes a thin film transistor (TFT) and a pixel electrode. The structure and function of elements in the pixel structure 312 are similar to those in the conventional liquid crystal display and will not be elaborated hereinafter.

In the embodiment, the display panel 310 is an in-cell touch panel, i.e. the sensing element is built in each pixel structure. Referring to FIG. 3, the pixel structure 312 includes a vertical sensing element 314 for sensing vertical position and a horizontal sensing element 316 for sensing horizontal position. The sensing elements 314 and 316 of the present invention can be any built-in sensing element commonly used in the touch panel, such as a protrusion structure between the TFT array substrate and the color filter substrate. When an object touches the display panel 310, the sensing element corresponding to the touch position will electrically conduct the TFT array substrate and the color filter substrate, so as to determine the coordinates of the touch position by detecting the voltage drop caused by the short-circuit of the two substrates. It is noted that though each pixel includes one horizontal sensing element and one vertical sensing element in this embodiment, in other embodiments, the density of the sensing elements can be varied with the desired touch sensing resolution.

The sensing signal sensed by the vertical sensing element in each pixel structure can be outputted through the vertical sensing lines Y(1), Y(2), . . . , Y(2^{m}), wherein m is a positive integer. The sensing signal sensed by the horizontal sensing element in each pixel structure can be outputted through the horizontal sensing lines X(1), X(2), . . . , X(2ⁿ), wherein n is a positive integer. In the embodiment, it is assumed that the number of the vertical sensing lines is 2^{m}, and the number of the horizontal sensing lines is 2ⁿ. The number of the vertical or horizontal sensing lines is typically associated with the resolution of the display panel 310. For example, if each pixel structure has 3 RGB sub-pixels, every 4 adjacent pixel structures in the horizontal direction are connected to a same vertical sensing line, every 4 adjacent pixel structures in the vertical direction are connected to a same horizontal sensing line, and the number of the vertical and horizontal sensing lines are respectively 2^{m} and 2ⁿ, then the resolution of the display panel 310 is (4×2ⁿ)×3×(4×2^{m}).

Referring to FIG. 3 again, the gate-line driving circuit 340 and the data-line driving circuit 350 are configured to update the display data stored in each pixel structure of the display panel 310. In general, each pixel structure can be driven by one gate line and three data lines. The gate-line driving circuit 340 can input the gate-line control signal through a plurality of gate lines (not shown) to drive the thin film transistor of the pixel structure. The data-line driving circuit 350 can send the display data signal to each pixel structure through a plurality of data lines (not shown). The structure and driving manner of the gate line and the data line are well known in the art and will not be described in detail, so as not to unnecessarily obscure the present invention.

Referring to FIG. 3, 2^{m} vertical sensing lines Y(1), Y(2), . . . , Y(2^{m}) are connected to the vertical voltage selector 320, and 2ⁿ horizontal sensing lines X(1), X(2), . . . , X(2ⁿ) are connected to the horizontal voltage selector 330. The vertical voltage selector 320 consists of a plurality of switches (typically N-type or P-type transistors). Under the control of m control signals, the vertical voltage selector 320 is configured to output one of the 2^{m} (or less) input signals from a single output end 322. In the embodiment of FIG. 3, the vertical voltage selector 320 receives vertical sensing signals from the 2^{m} vertical sensing lines Y(1), Y(2), . . . , Y(2^{m}) and also receives vertical control signals 362 from m vertical control lines of the control chip 360. The vertical voltage selector 320 outputs one of the vertical sensing signals to the control chip 360 from the output end 322 based on the vertical control signals 362 from the m vertical control lines. As such, the control chip 360 can control the vertical voltage selector 320 to sequentially output signals of the 2^{m} vertical sensing lines Y(1), Y(2), . . . , Y(2^{m}), by changing the vertical control signals 362 of the m vertical control lines. Similarly, The horizontal voltage selector 330 receives horizontal sensing signals from the 2ⁿ horizontal sensing lines X(1), X(2), . . . , X(2ⁿ) and sequentially outputs signals of the 2ⁿ horizontal sensing lines X(1), X(2), . . . , X(2ⁿ) to the control chip 360 from the output end 332 based on the horizontal control signals 364 from the n horizontal control lines of the control chip 360. The control chip 360 can determine the vertical coordinate and the horizontal coordinate of the touch position based on the outputted signals from the voltage selectors 320 and 330. Since signals from each horizontal sensing line and each vertical sensing line are sequentially outputted to the control chip 360, the position of each touch point can be precisely and independently determined to fulfill the multi-point touch function.

It can be seen from the embodiment of FIG. 3 that the voltage selectors 320 and 330 respectively require only m and n control lines to convert 2^{m} and 2ⁿ sensing lines into a single output line. Therefore, not only the frame width of the display device 300 can be reduced, but also the number of pins required in the control chip 360 is decreased. Moreover, in the embodiment of FIG. 3, the vertical voltage selector 320 is disposed on the left side of the display panel 310. For the layout balance, the gate-line driving circuit 340 is thus disposed on the right side of the display panel 310. However, it is noted that the relative position of elements in the touch display device 300 is not limited thereto, which can be modified as appropriate.

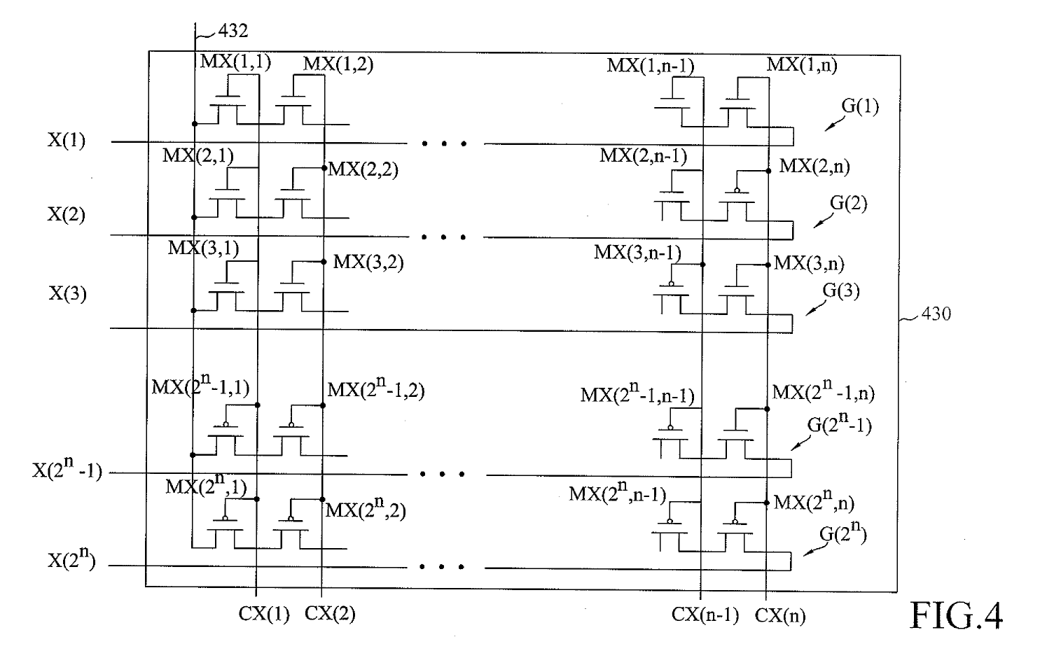

FIG. 4 illustrates a logic circuit diagram of a voltage selector 430 in accordance with one embodiment of the present invention. The voltage selector 430 includes 2ⁿ selecting units G(1) to G(2ⁿ), wherein each selecting unit includes n switch elements connected in series. That is, the voltage selector 430 includes (n×2ⁿ) switch elements. In the embodiment, the switch element is a P-type transistor or an N-type transistor, and the P-type transistors and the N-type transistors in each selecting unit G(1)-G(2ⁿ) are arranged in different manner. In the embodiment of FIG. 4, the P-type transistors and the N-type transistors in the selecting units G(1)-G(2ⁿ) are arranged in binary manner. In other words, the selecting unit G(1) consists of n N-type transistors MX(1, 1)-MX(1, n) sequentially connected in series; the selecting unit G(2) consists of n−1 N-type transistors MX(2, 1)-MX(2, n−1) and one P-type transistor MX(2, n) sequentially connected in series; the selecting unit G(3) consists of n−2 N-type transistors MX(3, 1)-MX(3, n−2), one P-type transistor MX(3, n−1), and one N-type transistor MX(3, n) sequentially connected in series; . . . ; the selecting unit G(2ⁿ−1) consists of n−1 P-type transistors MX(2ⁿ−1, 1)-MX(2ⁿ−1, n−1) and one N-type transistor MX(2ⁿ−1, n) sequentially connected in series; and the selecting unit G(2ⁿ) consists of n P-type transistors MX(2ⁿ,1)-MX(2ⁿ, n) sequentially connected in series.

As shown in FIG. 4, the 2ⁿ selecting units G(1)-G(2ⁿ) are configured to receive signals from the sensing lines X(1)-X(2ⁿ) and their outputs are all connected to the output end 432, wherein the ON/OFF state of n transistors in each selecting unit G(1)-G(2ⁿ) is controlled by the n control lines CX(1)-CX(n), respectively. As such, under the control of the n control lines CX(1)-CX(n), one of the signals from the sensing lines X(1)-X(2ⁿ) can be sent to the output end 432. Furthermore, by changing the control signals of the n control lines CX(1)-CX(n) with time, the signals from the sensing lines X(1)-X(2ⁿ) can be sequentially sent to the output end 432. For example, at a first time point, signals from the control lines CX(1)-CX(n) can be all at high level (i.e. signals from the control lines CX(1)-CX(n) are H, H, . . . , H, respectively). At this point, only transistors in the selecting unit G(1) are all in the ON state, and only the signal from the sensing line X(1) can be sent to the output end 432. At a next time point, the control lines CX(1)-CX(n) can send the control signals H, H, . . . , H, L, so that only the signal from the sensing line X(2) can be sent to the output end 432. Similarly, at different time points, the signals from the sensing lines X(1)-X(2ⁿ) can be sequentially outputted from the output end 432.

In one embodiment, when performing the circuit layout on the voltage selector 430 of FIG. 4, different types of transistors in each selecting unit can be separately disposed. In other words, for each selecting unit, all N-type transistors can be disposed together and all P-type transistors can be disposed together, so that each selecting unit has at most one interface of the N-type transistor and the P-type transistor. It is noted that when the above layout is employed, each transistor should be connected to the corresponding control line. For example, for the layout of the selecting unit G(3) of FIG. 4, all N-type transistors (i.e. MX(3, 1)-MX(3, n−2) and MX(3, n)) are first sequentially connected in series and then connected to the P-type transistor MX(3, n−1), wherein the P-type transistor MX(3, n−1) is still connected to the control line CX(n−1), and the N-type transistor MX(3, n) is still connected to the control CX(n).

Based on the design rule for common integrated circuit design, two adjacent transistors of the same type can use common source/drain, while a metal connection structure must be interposed between adjacent transistors of different type. Consequently, as the number of interfaces of N-type transistor and P type-transistor increases, the required layout becomes larger. Therefore, the layout arrangement of separating the transistors of different type as described above can effectively reduce the required layout area for the voltage selector.

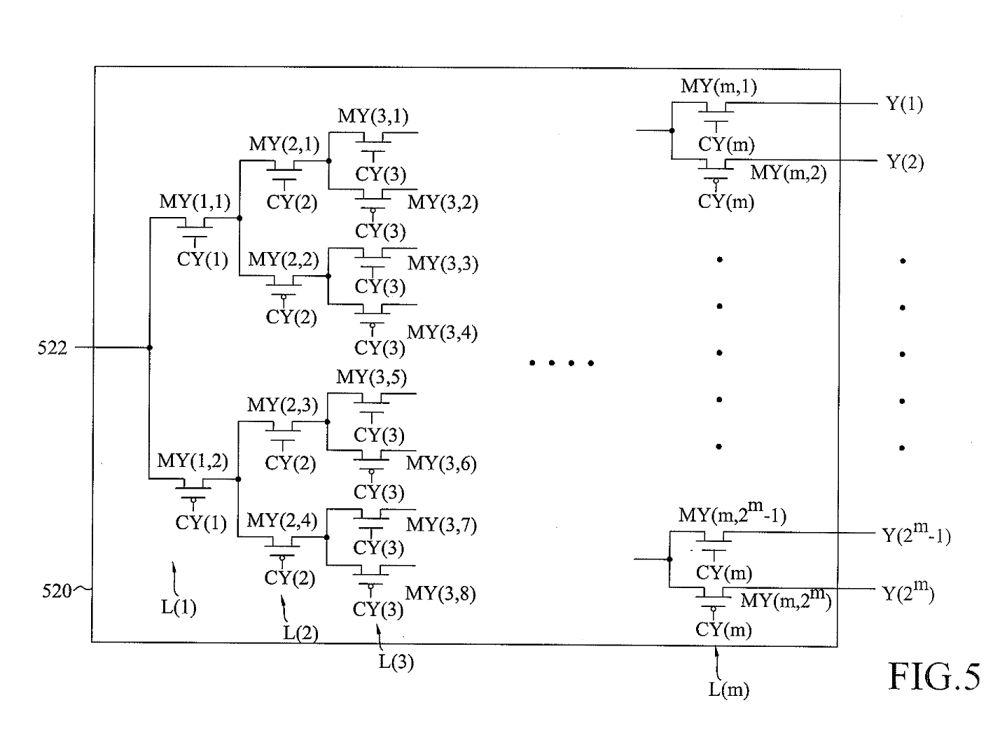

FIG. 5 illustrates a logic circuit diagram of a voltage selector 520 in accordance with another embodiment of the present invention. The voltage selector 520 is an m-level structure including m selecting units L(1)-L(m), wherein the p^{th} selecting unit includes 2^{p} switch elements. By means of a general geometric series calculation, the voltage selector 520 includes 2×(2^{m}−1) switch elements. In comparison with the voltage selector 430 of FIG. 4 including (n×2ⁿ) switch elements, the voltage selector 520 of FIG. 5 can be realized by fewer switch elements. In the embodiment of FIG. 5, the switch element is a P-type transistor or an N-type transistor, and each selecting unit includes same number of P-type and N-type transistors. For example, the 2^{nd} selecting unit L(2) includes 2 N-type transistors MY(2, 1), MY(2, 3) and 2 P-type transistors MY(2, 2), MY(2, 4).

It can be seen from FIG. 5, starting from the 1^{st} selecting unit L(1), each transistor is connected to one p-type transistor and one N-type transistor in the next selecting unit. For example, the transistor MY(1, 1) in the selecting unit L(1) is connected to the N-type transistor MY(2, 1) and the P-type transistor MY(2, 2) in the selecting unit L(2); the P-type transistor MY(2, 2) in the selecting unit L(2) is connected to the N-type transistor MY(3, 3) and the P-type transistor MY(3, 4) in the selecting unit L(3); and so on to the m−1^{th} selecting unit. Then, the 2^{m} transistors in the m^{th} selecting unit L(m) respectively receive signals from the sensing lines Y(1)-Y(2^{m}), and these signals are finally outputted from the output end 522 via different paths through every selecting unit. The ON/OFF state of transistors in M selecting units L(1)-L(m) is respectively controlled by the m control lines CY(1)-CY(m) to selectively send the signal from one of the sensing lines Y(1)-Y(2^{m}) to the output end 522. Furthermore, by changing the control signals of the m control lines CY(1)-CY(m) with time, the signals from the sensing lines Y(1)-Y(2^{m}) can be sequentially sent to the output end 522. In other words, under the control of m control lines, signals from the 2^{m} sensing lines can be outputted from a single output end.

Compared to the conventional touch display device, in which all horizontal and vertical sensing lines are directly routing connected to the control chip, the touch display panel of the present invention adds the voltage selector to significantly reduce the number of sensing lines connected to the control chip. Consequently, the present invention can not only decrease the number of pins for external connection required in the control chip, but also reduce the overall dimension of the touch display device to further reduce the manufacturing cost.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A touch display device, comprising:
a display panel comprising a plurality of sensing elements arranged in matrix form;
a plurality of horizontal sensing lines respectively connected to the plurality of sensing elements;
a horizontal voltage selector for receiving a plurality of horizontal sensing signals from the plurality of horizontal sensing lines; and
a control chip for outputting a plurality of horizontal control signals to the horizontal voltage selector;
wherein the horizontal voltage selector outputs one of the plurality of horizontal sensing signals to the control chip based on the plurality of horizontal control signals.

2. The touch display device of claim 1, wherein the number of the plurality of horizontal control signals is n, the number of the plurality of horizontal sensing signals is less than or equal to 2ⁿ, wherein n is a positive integer.

3. The touch display device of claim 2, wherein the horizontal voltage selector has an output end, the plurality of horizontal control signals control the horizontal voltage selector to sequentially output the plurality of horizontal sensing signals to the control chip from the output end.

4. The touch display device of claim 2, wherein the horizontal voltage selector comprises 2ⁿ selecting units, each of the 2ⁿ selecting units comprises n switch elements connected in series, the 2ⁿ selecting units respectively receive the plurality of horizontal sensing signals.

5. The touch display device of claim 4, wherein the switch element is a P-type transistor or an N-type transistor, each of the 2ⁿ selecting units comprises P-type transistors and N-type transistors arranged in different order.

6. The touch display device of claim 5, wherein each of the 2ⁿ selecting units has at most one interface of the N-type transistor and the P-type transistor.

7. The touch display device of claim 2, wherein the horizontal voltage selector comprises n selecting units connected in series, the p^{th} selecting unit comprises 2^{p} switch elements, wherein 2ⁿ switch elements of the n^{th} selecting unit respectively receive the plurality of horizontal sensing signals, the 2¹ switch elements of the 1^{st} selecting unit are connected to the control chip.

8. The touch display device of claim 7, wherein the switch element is a P-type transistor or an N-type transistor, each of the n selecting units comprises same number of P-type transistors and N-type transistors.

9. The touch display device of claim 1, further comprising:
a plurality of vertical sensing lines respectively connected to the plurality of sensing elements, wherein the plurality of vertical sensing lines are perpendicular to the plurality of horizontal sensing lines; and
a vertical voltage selector for receiving a plurality of vertical sensing signals from the plurality of vertical sensing lines;
wherein the control chip further outputs a plurality of vertical control signals to the vertical voltage selector, the vertical voltage selector outputs one of the plurality of vertical sensing signals to the control chip based on the plurality of vertical control signals.

10. The touch display device of claim 9, wherein the plurality of sensing elements further comprises a plurality of horizontal sensing elements and a plurality of vertical sensing elements, the plurality of horizontal sensing lines and the plurality of vertical sensing lines are connected to the plurality of horizontal sensing elements and the plurality of vertical sensing elements, respectively.

11. The touch display device of claim 10, wherein the display panel further comprises a plurality of pixel structures, each pixel structure comprises three sub-pixels and a portion of the plurality of sensing elements.

12. An electronic apparatus, comprising the touch display device of claim 1, wherein the electronic apparatus is a mobile phone, a digital camera, a personal digital assistant, a laptop computer, a desktop computer, a television, a global positioning system, a head-up display, an aviation display, a digital frame, or a portable DVD player.
